(19) United States
(12) Patent Application Publication
(10) Pub. No.: US 2004/0155125 A1
(43) Pub. Date: Aug. 12, 2004

(54) High pressure fluid jet nozzles and methods of making

(76) Inventors: Martin S. Kramer, Clarkston, MI (US); Tracy L. Kramer, Clarkston, MI (US); Larry E. Byrnes, Rochester Hills, MI (US); Rodney K. Elnick, Washington, MI (US)

Correspondence Address: LESLIE C. HODGES, General Motors Corporation, Legal Staff, Mail Code 482-C23-B21, P.O. Box 300, Detroit, MI, 48265-3000, US

(21) Appl. No.: 10/364,206

(22) Filed: Feb. 11, 2003

(51) Int. Cl. B05B 1/26

(52) U.S. Cl. 239/601

(57) ABSTRACT

A high pressure fluid jet nozzle has a generally cylindrical body with inlet and outlet ends, a through passage with an entry portion extending to at least one laser cut orifice at the outlet end of the body. The body has a smooth outlet end through which the laser is configured entirely by laser cutting. The entry portion of the through passage preferably has a hemispherical end penetrated by the orifice. Manufacturing steps including laser cutting of the orifice or orifices and optional electrical discharge machining of the hemispherical end of the entry portion.

### TECHNICAL FIELD

This invention relates to fluid jet nozzles for high pressure water spraying and the like and to methods of making such nozzles.

### BACKGROUND OF THE INVENTION

It is known in the art to use high pressure water jet methods for treating low density metallic surfaces, such as engine aluminum cylinder bores, to prepare them for thermal spray coating. Various forms of nozzles for the water jet treating method have been developed, including some which provide specifically shaped nozzle openings for directing water jets against a metallic surface to roughen it for coating. Some of the nozzle configurations require machining practices with particularly accurate machining tolerances in order to obtain satisfactory repeatability among similarly manufactured nozzles, resulting in a relatively high scrap rate.

### SUMMARY OF THE INVENTION

The present invention provides improved nozzle designs and methods of manufacture which permit more accurate machining of the critical dimensions of the nozzle, including the configuration of the orifice or orifices through which high pressure fluid jets are projected.

A feature of the invention is that each nozzle is provided with at least one laser cut orifice extending through an outlet end from a discharge end of an entry portion into which the spray fluid is introduced.

An additional optional feature is that the entry portion of the nozzle has a discharge end which is hemispherical in configuration.

A feature of the manufacturing method is that the nozzle orifice or orifices are formed by laser cutting which is able to provide accurate nozzle shapes of any desired configuration.

An additional optional feature is that the hemispherical discharge end of the entry portion is accurately formed by electrical discharge machining.

Various nozzle configuration proposed for high pressure water spray treatment of aluminum cylinders and for other purposes are also included as part of the invention.

These and other features and advantages of the invention will be more fully understood from the following description of certain specific embodiments of the invention taken together with the accompanying drawings.

### BRIEF DESCRIPTION OF THE DRAWINGS

FIG. 1 is a side view of a first embodiment of high pressure fluid jet nozzle according to the invention.

FIG. 2 is a cross-sectional view of the nozzle from the line 2-2 of FIG. 1.

FIG. 3 is an end view of the nozzle interior from the line 3-3 of FIG. 2.

FIG. 4 is an enlarged outlet end view of the nozzle orifice from the line 4-4 of FIG. 2.

FIG. 5 is a view similar to FIG. 4 illustrating a second embodiment of orifice configuration.

FIG. 6 is a pictorial cross-sectional view showing the orifice configuration of FIG. 5.

FIGS. 7 and 8 are views similar to FIGS. 5 and 6 but showing a third embodiment of nozzle orifice.

FIGS. 9 and 10 are view similar to FIGS. 7 and 8 but showing a fourth embodiment of orifice configuration.

FIGS. 11 and 12 are views similar FIGS. 5 and 6 but showing a fifth embodiment of orifice configuration.

FIG. 13 is a fragmentary cross-sectional view of a nozzle discharge end showing a sixth embodiment of orifice configuration having multiple orifices.

FIG. 14 is an outer end view of the orifices of FIG. 13.

FIG. 15 is a cross-sectional pictorial view illustrating the orifice spray pattern of the embodiment of FIGS. 13 and 14.

FIGS. 16, 17, and 18 are figures similar to FIGS. 13, 14, and 15 but illustrating a seventh embodiment of multiple orifice spray pattern.

FIG. 19 is a view similar to FIG. 16 but showing an eighth embodiment of parallel orifices and their spray pattern.

FIG. 20 is a flow chart illustrating steps in a method of manufacture of a nozzle in accordance with the invention.

### DESCRIPTION OF THE PREFERRED EMBODIMENT

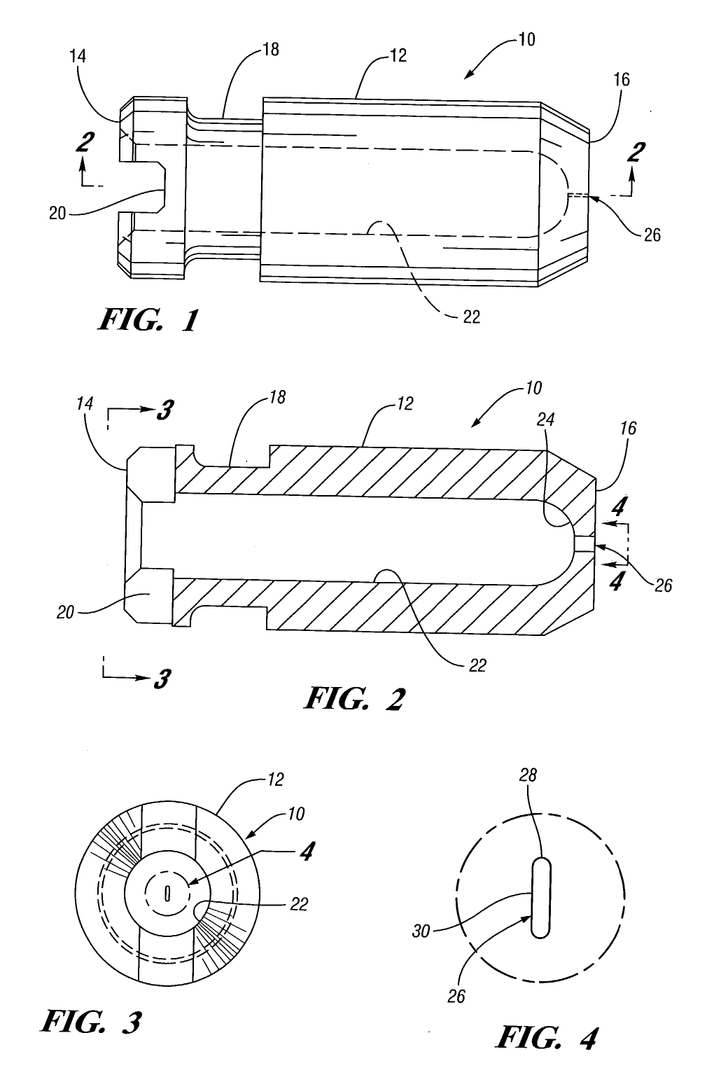

Referring first to FIGS. 1-4 of the drawings, numeral 10 generally indicates a high pressure fluid jet nozzle formed in accordance with the invention. Nozzle 10 includes a generally cylindrical body 12 having an inlet end 14 and an outlet end 16. A seal groove 18 is formed around the body near the inlet end which is also provided with a transverse alignment slot 20 at the inlet end 14.

The body includes an internal entry portion 22 forming a fluid chamber which extends longitudinally from the open inlet end 14 to a point closely adjacent the outlet end 16. The entry portion preferably terminates at a hemispherical discharge end 24.

A laser cut orifice 26 extends through the outlet end from the discharge end of the entry portion 22 to the exterior of the nozzle. The outlet end of the nozzle is generally flat with an unbroken end surface. However, a curved or otherwise smooth or unbroken end surface could be provided if desired. The nozzle orifice 26 comprises a first illustrative embodiment formed with a generally rectangular configuration having rounded ends 28 and straight non-angular sides 30.

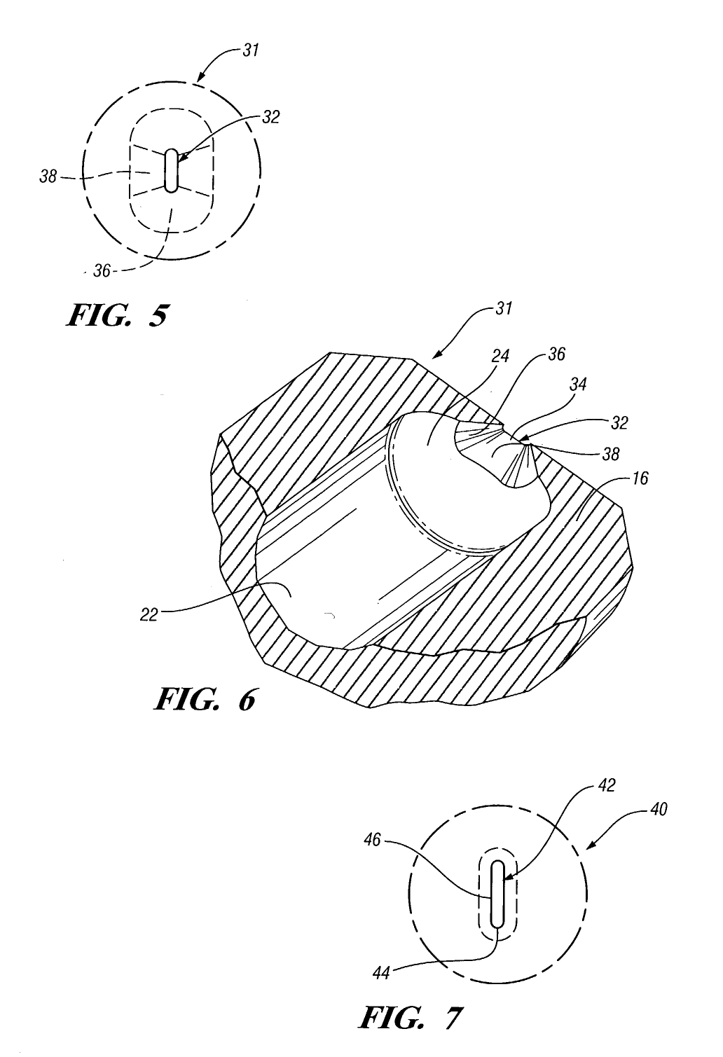

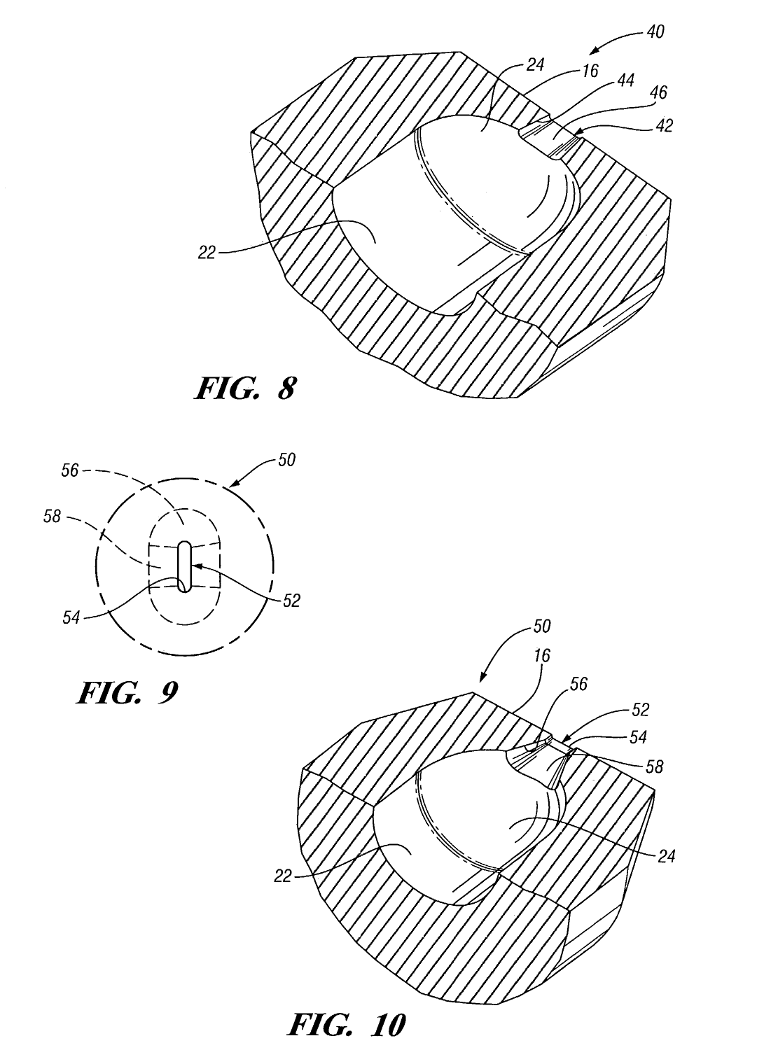

Referring now to FIGS. 5 and 6, a second embodiment of nozzle 31 having an orifice 32 is illustrated wherein the outlet opening 34 is configured as in orifice 26. However, the ends 36 and sides 38 of the orifice converge inward with an approximate 60 degree included angle or about 30 degrees inward in the radial direction as the orifice extends from the hemispherical end 24 of the nozzle. The arrangement reduces the entry angle of the orifice from the entry portion 22 or water chamber so that a more laminar flow of the fluid results.

Referring now to FIGS. 7 and 8, a third embodiment of nozzle 40 having an orifice 42 is illustrated wherein the ends and sides 44, 46 converge inward toward the end opening at only a 16 degree included angle. This arrangement reduces the knife edge condition at the exit orifice and provides a more collimated water or fluid jet from the nozzle 40.

FIGS. 9 and 10 illustrate a nozzle 50 having an orifice 52 similar to that of FIGS. 5 and 6 but differing in the provision of a very short straight throat 54 at the exit of the orifice. Inwardly, the ends 56 and the sides 58 of the orifice are angled with a 60 degree included angle.

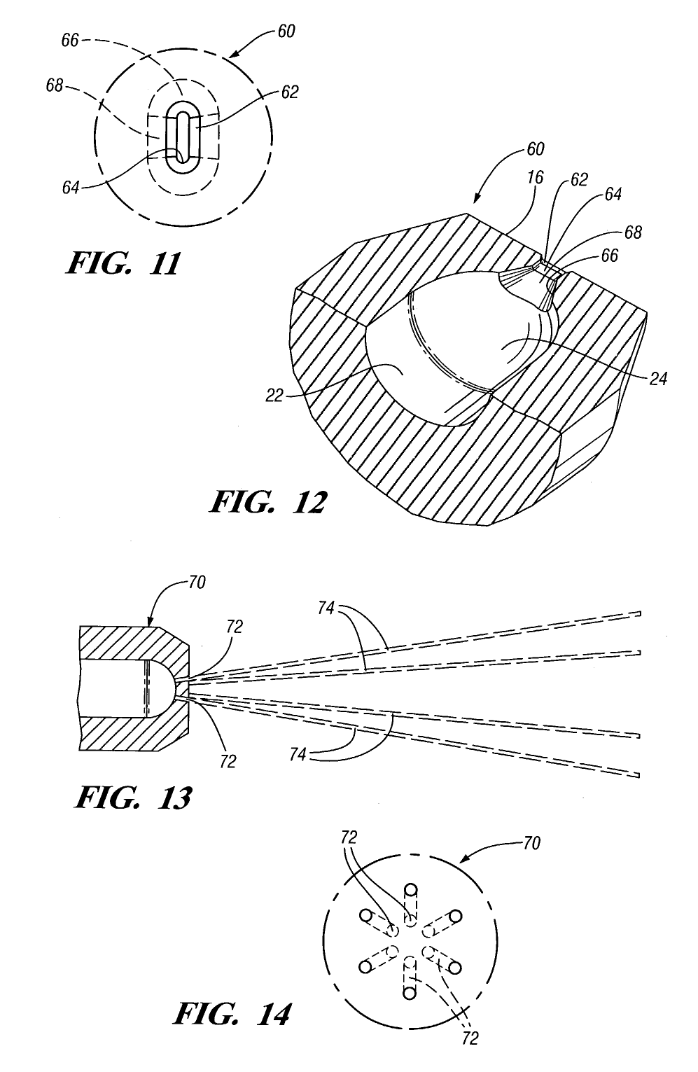

FIGS. 11 and 12 show another embodiment of nozzle 60 which is similar to that of FIGS. 9 and 10 except that the nozzle outlet has a short divergent length 62 at the outlet, with a straight throat 64 and 60 degree included angle converging ends and sides 66, 68 inwardly of the throat. All these surfaces of the various nozzle configurations may be machined or formed by the laser machining process.

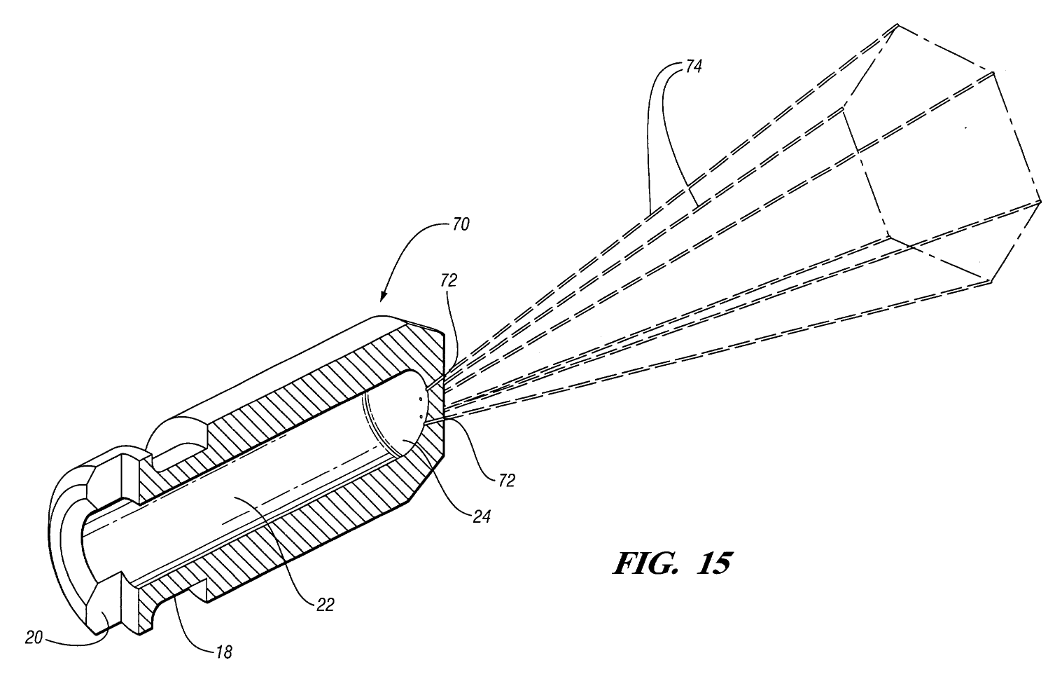

FIGS. 13-15 disclose another embodiment of nozzle 70 having a plurality of orifices 72 which extend through the end 16 of the nozzle at an outward angle of about 17 degrees to form a diverging pattern of individual nozzle jets 74.

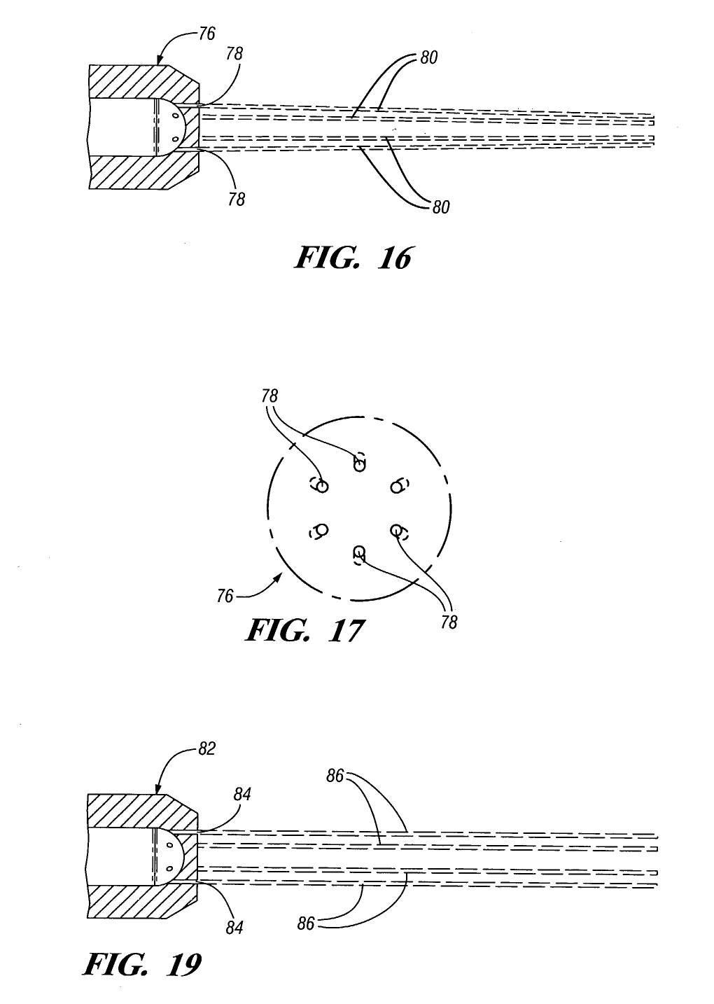

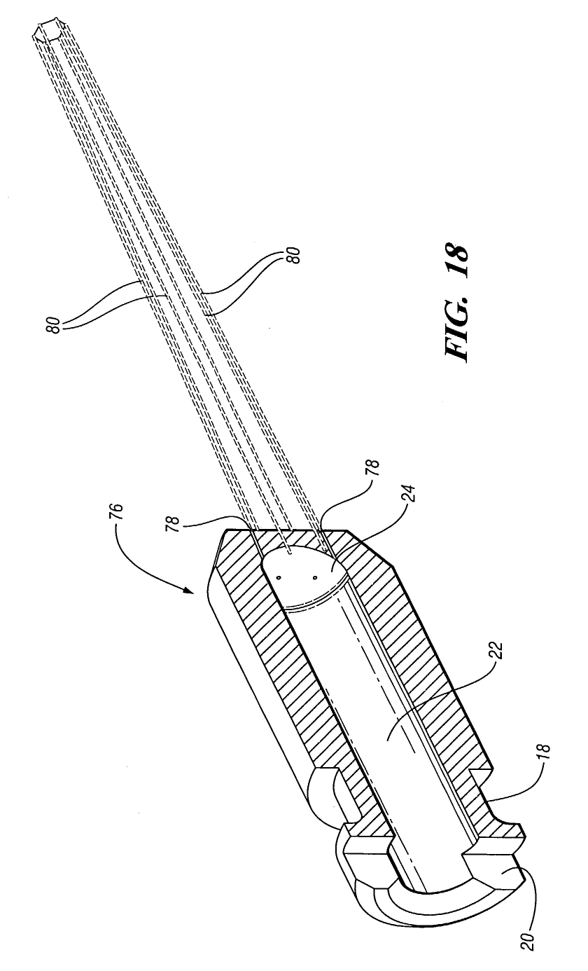

FIGS. 16-18 illustrate an embodiment similar to FIGS. 13-15 except that the nozzle 76 includes orifices 78 which are angled slightly inward to form a converging pattern of jets 80.

FIG. 19 illustrates another embodiment of nozzle 82 wherein multiple orifices 84 are aligned in a parallel pattern of jets 86.

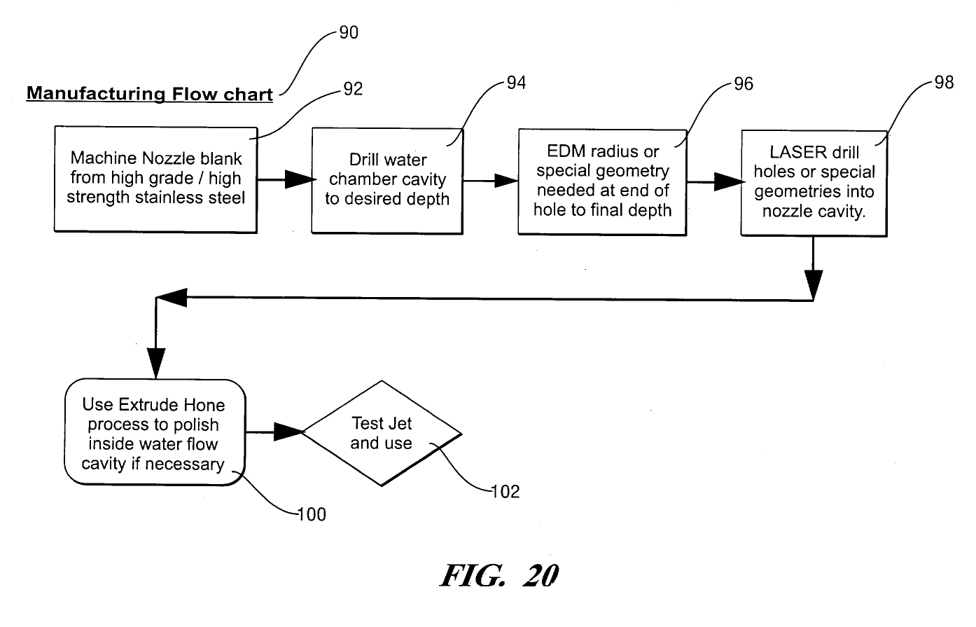

FIG. 20 is a flow chart 90 illustrating both required and optional steps in the manufacture of nozzles according to the invention. The steps include: 92—machining a nozzle blank from high grade/high strength stainless steel, 94—drilling a water chamber or entry portion cavity to a desired depth, 96—electrical discharge machining a hemispherical or other shaped end of the water chamber cavity, 98—laser forming one or more orifices through the outlet end into the nozzle cavity, 100—optionally using an extrude hone process to internally polish the water flow cavity, and 102—testing the nozzle jet.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A high pressure fluid jet nozzle having a generally cylindrical body with inlet and outlet ends and including a through passage comprising:
an entry portion extending longitudinally through the body to a discharge end at the outlet end of the body; and
at least one laser cut orifice through the outlet end from the discharge end wherein the outlet end of the nozzle has a generally unbroken end surface through which the at least one orifice opens to an exterior of the nozzle and the configuration of the orifice opening through the outlet end is determined entirely by the laser cutting of the orifice.

2. A nozzle as in claim 1 wherein the outlet end of the nozzle is essentially flat.

3. A nozzle as in claim 1 wherein the discharge end of the entry portion is essentially hemispherical.

4. A nozzle as in claim 1 wherein the discharge end of the entry portion is formed by electrical discharge machining.

5. A nozzle as in claim 1 wherein the orifice is essentially a straight sided rectangle having a radiused rectangular outlet.

6. A nozzle as in claim 1 wherein the orifice is essentially a converging angular sided rectangle with a radiused rectangular outlet.

7. A nozzle as in claim 1 wherein the orifice is essentially a converging angular sided rectangle with a radiused rectangular outlet having a straight throat at the outlet.

8. A nozzle as in claim 7 including a diverging exit portion between the straight throat and the orifice outlet.

9. A nozzle as in claim 1 wherein the orifice is essentially a laser cut ellipse with shallow angled sides and a straight throat at the outlet.

10. A nozzle as in claim 1 wherein the at least one orifice is a plurality of laser drilled holes.

11. A nozzle as in claim 10 wherein the orifice holes form a diverging pattern.

12. A nozzle as in claim 10 wherein the orifice holes form a parallel pattern.

13. A nozzle as in claim 10 wherein the orifice holes form a converging pattern.

14. A nozzle as in claim 1 wherein the nozzle includes an indicator at the inlet end for guiding positioning of the nozzle in the discharge device.

15. A nozzle as in claim 14 wherein the indicator is a transverse slot having a predetermined angular relation to the orifice.

16. A method of making a nozzle for discharging high pressure fluid jets, the method comprising:
forming a generally cylindrical nozzle body having inlet and outlet ends and a through passage between the ends;
forming an entry portion of the passage extending from the inlet end to adjacent the outlet end; and
forming an orifice through the outlet end from the entry portion, the orifice being accurately configured by laser cutting.

17. A method as in claim 16 wherein the step of forming an entry portion is at least completed by electrical discharge machining to obtain a predetermined interior configuration.

18. A method as in claim 17 wherein the predetermined interior configuration is spherical adjacent the outlet end of the orifice.

19. A method as in claim 16 including internally polishing the entry portion with an extrude hone process.
